(19) United States
(12) Patent Application Publication
(10) Pub. No.: US 2024/0336874 A1
(43) Pub. Date: Oct. 10, 2024

(54) SOLID 2-IN-1 DETERGENT RINSE FORMULA FOR UNDER-COUNTER MACHINE WARE WASH

(71) Applicant: ECOLAB USA INC., Saint Paul, MN (US)

(72) Inventors: Sven Klose, Essen (DE); Aleksandr Gelenberg, Dortmund (DE); Tobias Foster, Cologne (DE); Mara Carver, Saint Paul, MN (US); Nathan Peitersen, Saint Paul, MN (US); Aure-Anne Masdupuy, Saint Paul (DE)

(21) Appl. No.: 18/627,962

(22) Filed: Apr. 5, 2024

Related U.S. Application Data
(60) Provisional application No. 63/494,425, filed on Apr. 5, 2023.

(51) Int. Cl. C11D 1/722; C11D 3/10; C11D 3/14; C11D 3/33; C11D 3/37

(52) U.S. Cl. CPC C11D 1/722; C11D 3/10; C11D 3/14; C11D 3/33; C11D 3/3757

(57) ABSTRACT

This disclosure relates to solid 2-in-1 warewash compositions that provide both detergency and rinsing properties. The disclosure also describes method of manufacture and methods of use. The solid 2-in-1 warewash compositions are particularly suitable for under-counter machines. Beneficially, the solid warewash compositions can provide a controlled dissolution rate. Additionally, the solid warewash compositions can have structural integrity in thin configurations.

### CROSS-REFERENCE TO RELATED APPLICATION

This application claims priority under 35 U.S.C. § 119 to Provisional Application Ser. No. 63/494,425, filed on Apr. 5, 2023, which is herein incorporated by reference in its entirety including without limitation, the specification, claims, and abstract, as well as any figures, tables, or examples thereof.

### TECHNICAL FIELD

This disclosure relates to solid 2-in-1 warewash compositions that provide both detergency and rinsing properties. The disclosure also describes method of manufacture and methods of use. The solid 2-in-1 warewash compositions are particularly suitable for under-counter machines.

### BACKGROUND

A dishwasher, also referred to as a dishmachine, warewasher or warewashing machine, is a machine for automatically cleaning articles, such as dishes, trays, laboratory equipment, dinnerware, and kitchenware. A batch of objects to be cleaned (for example, dishes) can be loaded into a tub of the dishwasher, typically including racks and utensil holders, to be cleaned in a cleaning cycle that include washing and rinsing periods. During the washing period, a cleaning mixture formed by water and dishwasher detergent is sprayed into the loaded tub to blast the dishes. The cleaning mixture is then drained before the rinsing period starts. During the rinsing period, water is sprayed into the washing chamber to remove residue of the cleaning mixture. After the rinsing period complete with the rinsing water being drained, the dishes can optionally be dried using air and/or heat during a drying period. A dishwasher may have various user-selectable settings for each cleaning cycle. The settings may define, for example, time, temperature, and repetition of each of the washing, rinsing, and drying period. The setting may also allow the user to choose which periods to include (e.g., rinsing only, drying only, rinsing and drying, or washing and rinsing without drying).

One type of dishmachine is an undercounter unit intended to be installed under a kitchen counter. Other types of dishmachine include industrial or commercial dishmachine for use in restaurants, hotels, and other commercial establishments with food services. Warewash detergents used in these dishmachines can include chemicals capable of cleaning, sanitizing, and/or reducing surface tension of water (and hence water spots on dishes). Such warewash detergents are made into various solid and liquid forms. Solid warewash detergents include chemicals made in forms of solid blocks such as tablets in various shapes.

Given the limited space under in undercounter dishmachines, there are considerations regarding the shape and size of the detergent. The ability to shape a warewash detergent into a slim configuration (e.g., like a bread slice) or other shapes is important to adapt to different size and shape configurations. A difficulty however remains in formulating a detergent that maintains structural integrity (e.g., does not crumble or crack) but also includes high efficacy as to cleaning. Lastly, many detergents also are best used with a separate rinse aid. This is particularly important for cleaning plastics and some glassware. Thus, further improvements still remain unmet within the art of warewashing.

Accordingly, it is an objective of this disclosure to provide an improved detergent composition that provides both detergency and rinsing properties.

A further object of this disclosure is to provide a solid composition that retains structural integrity in a thin shape.

Still a further object of this disclosure is a detergent that has a controlled dissolution rate.

Other objects, advantages and features of this disclosure will become apparent from the following specification taken in conjunction with the accompanying figures.

### BRIEF SUMMARY OF PREFERRED EMBODIMENTS

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

This disclosure provides a preferred embodiment of a warewash composition comprises from about 20 wt. % to about 80 wt. % of an alkali metal carbonate; from about 0.1 wt. % to about 12 wt. % of a fatty alcohol alkoxylate, wherein the fatty alcohol alkoxylate has between about 10 and about 20 moles of ethoxylation, between about 10 and about 20 moles of propoxylation, and a carbon chain length of from about 5 to about 15; and a water conditioning agent; and wherein the warewash composition is a solid.

This disclosure also provides a preferred embodiment of a method of manufacturing the warewash composition comprising obtaining a solid premix, a liquid premix, and the fatty alcohol alkoxylate; wherein the solid mixture comprises the alkali metal carbonate, and the liquid premix comprises the water conditioning agent; combining the solid premix, liquid premix, and the fatty alcohol alkoxylate to form a mixture; and solidifying the mixture.

This disclosure also provides a method of cleaning and rinsing a ware comprising contacting the ware with a solid warewash composition comprising from about 20 wt. % to about 80 wt. % of an alkali metal carbonate; from about 0.1 wt. % to about 12 wt. % of a fatty alcohol alkoxylate, wherein the fatty alcohol alkoxylate has between about 10 and about 20 moles of ethoxylation, between about 10 and about 20 moles of propoxylation, and a carbon chain length of from about 5 to about 15; and a water conditioning agent; and rinsing the ware.

While multiple embodiments are disclosed, still other embodiments will become apparent to those skilled in the art from the following detailed description, examples, and accompanying figures, which shows and describes illustrative preferred embodiments. Accordingly, the figures and detailed description are to be regarded as illustrative in nature and not restrictive.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE FIGURES

FIG. 1 is a graph showing the rinsing efficacy of a commercial detergent, a commercial detergent and rinse aid, water, and a 2:1 formulation.

FIG. 2 is a graph showing the rinsing efficacy of a commercial detergent, a commercial detergent and rinse aid, water, and 2:1 formulations comprising varying amounts and different surfactants.

Various embodiments will be described in detail with reference to the figures. Reference to various embodiments does not limit the scope of the inventions. Figures represented herein are not limitations to the various embodiments according to the inventions and are presented for exemplary illustration of the inventions.

### DETAILED DESCRIPTION

The present disclosure relates to solid warewash compositions and methods of manufacturing and using the same. The solid warewash compositions as described herein have many advantages over existing compositions. For example, the solid warewash compositions provide detergency and rinsing properties. Further, the solid warewash compositions can provide a controlled dissolution rate. Additionally, the solid warewash compositions can maintain structural integrity (e.g., not crumbling or cracking) in a variety of shapes, including, in particular, thin configurations such as a bread slice style.

The embodiments disclosed herein are not limited to particular cleaning systems, soils, or substrates, which can vary and are understood by skilled artisans; although in a preferred embodiment, the solid warewash compositions are suitable for use in an undercounter dishmachine. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the inventions. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

### Definitions

So that this disclosure may be more readily understood, certain terms are first defined. Unless defined otherwise, all technical and scientific terms used herein have the same meaning as commonly understood by one of ordinary skill in the art to which embodiments pertain. Many methods and materials similar, modified, or equivalent to those described herein can be used in the practice of the embodiments disclosed herein without undue experimentation, the preferred materials and methods are described herein. In describing and claiming the embodiments, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, mass, volume, time, molecular weight, molar ratio, molar percentages, and surface tension. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

As used herein, the term “analog” means a molecular derivative of a molecule. The term is synonymous with the terms “structural analog” or “chemical analog.”

As used herein, the term “oligomer” refers to a molecular complex comprised of between one and ten monomeric units. For example, dimers, trimers, and tetramers, are considered oligomers. Furthermore, unless otherwise specifically limited, the term “oligomer” shall include all possible isomeric configurations of the molecule, including, but are not limited to isotactic, syndiotactic and random symmetries, and combinations thereof. Furthermore, unless otherwise specifically limited, the term “oligomer” shall include all possible geometrical configurations of the molecule.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x” mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The methods and compositions of this disclosure may comprise, consist essentially of, or consist of the components and ingredients as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

An “antiredeposition agent” refers to a compound that helps keep suspended in water instead of redepositing onto the object being cleaned. Antiredeposition agents are useful to assist in reducing redepositing of the removed soil onto the surface being cleaned.

The term “weight percent,” “wt. %,” “wt-%,” “percent by weight,” “% by weight,” and variations thereof, as used herein, refer to the concentration of a substance as the weight of that substance divided by the total weight of the composition and multiplied by 100.

As used herein, the term “cleaning” refers to a method used to facilitate or aid in soil removal.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

As used herein, the phrase “food product” includes any food substance that might require treatment with an antimicrobial agent or composition and that is edible with or without further preparation. Food products include meat (e.g. red meat and pork), seafood, poultry, produce (e.g., fruits and vegetables), eggs, living eggs, egg products, ready to cat food, wheat, seeds, roots, tubers, leafs, stems, corns, flowers, sprouts, seasonings, or a combination thereof. The term “produce” refers to food products such as fruits and vegetables and plants or plant-derived materials that are typically sold uncooked and, often, unpackaged, and that can sometimes be eaten raw.

As used herein, the phrase “meat product” refers to all forms of animal flesh, including the carcass, muscle, fat, organs, skin, bones and body fluids and like components that form the animal. Animal flesh includes, but is not limited to, the flesh of mammals, birds, fishes, reptiles, amphibians, snails, clams, crustaceans, other edible species such as lobster, crab, etc., or other forms of seafood. The forms of animal flesh include, for example, the whole or part of animal flesh, alone or in combination with other ingredients. Typical forms include, for example, processed meats such as cured meats, sectioned and formed products, minced products, finely chopped products, ground meat and products including ground meat, whole products, and the like.

As used herein, the phrase “plant” or “plant product” includes any plant substance or plant-derived substance. Plant products include, but are not limited to, seeds, nuts, nut meats, cut flowers, plants or crops grown or stored in a greenhouse, house plants, and the like. Plant products include many animal feeds.

As used herein, the term “soil” or “stain” refers to organic and/or inorganic soils such as a non-polar oily substance which may or may not contain particulate matter such as mineral clays, sand, natural mineral matter, carbon black, graphite, kaolin, environmental dust, dirt, etc., and food soil including proteinaceous soils, starchy soils, polysaccharides, fatty soils including saturated and unsaturated fatty soils, food particulate and matter, etc.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the this disclosure include but are not limited to, those that include polypropylene polymers (PP), polycarbonate polymers (PC), melamine formaldehyde resins or melamine resin (melamine), acrilonitrile-butadiene-styrene polymers (ABS), and polysulfone polymers (PS). Other exemplary plastics that can be cleaned using the compounds and compositions of this disclosure include polyethylene terephthalate (PET) polystyrene polyamide.

The terms “water soluble” and “water dispersible” as used herein, means that the polymer is soluble or dispersible in water in the inventive compositions. In general, the polymer should be soluble or dispersible at 25° C. at a concentration of 0.0001% by weight of the water solution and/or water carrier, preferably at 0.001%, more preferably at 0.01% and most preferably at 0.1%.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods, systems, apparatuses, and compositions disclosed herein may comprise, consist essentially of, or consist of the components and ingredients as described and claimed as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

### Solid Warewash Compositions

This disclosure provides solid warewash compositions. Beneficially, the solid warewash compositions have good detergency and rinsing properties; thus, they are able to serve as a 2-in-1 composition fulfilling the roles of both a warewash detergent and a rinse aid. An additional benefit is that the solid warewash compositions can have a controlled dissolution rate. This provides for a desired dosing of the detergent and rinsing chemistry with each dissolution while permitting the solid to be used over multiple cleaning cycles in some embodiments. The solid warewash compositions also have the benefit of structural integrity such that they resist cracking and crumbling under ambient conditions, and even in increased temperatures and humidity due to the dishmachine cycle.

The solid warewash compositions comprise an alkali metal carbonate, a fatty alcohol alkoxylate, and a water conditioning agent. The solid warewash compositions can comprise a variety of additional ingredients disclosed herein. A preferred embodiment is provided in Table 1 below where each of the wt. % integers specified in the following table is to be considered preceded by the term “about”.

TABLE 1

| | First | Second | Third |
|---|---|---|---|
| | Example | Example | Example |
| Ingredient | Range wt. % | Range wt. % | Range wt. % |
| alkali metal carbonate | 20-80 | 35-70 | 45-65 |
| fatty alcohol alkoxylate | 0.1-12 | 1-11 | 2-10 |
| water conditioning agent | 10-35 | 12-30 | 15-28 |
| optional whitening agent | 0-15 | 0.01-12 | 1-10 |
| optional additional | 0-40 | 0.01-35 | 0.1-30 |
| functional ingredients | | | |

A use solution may be prepared from the warewash compositions disclosed in the preceding Table and this application by diluting the solid warewash composition with water at a dilution ratio that provides a use solution. The water that is used to dilute the concentrate to form the use solution can be referred to as water of dilution or a diluent, and can vary from one location to another. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water. Particularly, the concentrate is diluted at a ratio of between about 1:100 and about 1:5,000 concentrate to water. More particularly, the concentrate is diluted at a ratio of between about 1:250 and about 1:2,000 concentrate to water. In a use solution, the detergent composition is present between about 10 ppm and about 10,000 ppm, preferably between about 200 ppm and about 5000 ppm, more preferably between about 500 ppm and about 2000 ppm, and in a most preferred embodiment between about 750 ppm and about 1500 ppm.

In some embodiments, the warewash composition preferably provides efficacy at low use dilutions, i.e., require less volume to clean effectively. A detergent concentrate that requires less volume to achieve the same or better cleaning efficacy and provides hardness scale control and/or other benefits at low use dilutions is desirable. Further, in a preferred embodiment, the warewash composition has a controlled dissolution rate such that it can be used to form a use solution over multiple wash cycles. Most preferably the solid warewash composition can be used in 2 wash cycles, 3 wash cycles, 4 wash cycles, 5 wash cycles, 6 wash cycles, 7 wash cycles, 8 wash cycles, 9 wash cycles, 10 wash cycles, or more.

### Alkali Metal Carbonate

The warewash compositions comprise an alkali metal carbonate. Preferred alkali metal carbonates include, sodium carbonate, potassium carbonate, bicarbonate, sesquicarbonate, and mixtures thereof.

In a preferred embodiment the composition includes only, or mostly dense ash. In another preferred embodiment, dense ash and light ash (both disodium carbonate) are both used. Dense ash is more dense and has smaller particle size compared to light ash, while the compounds are the same chemically. In a preferred embodiment, the warewash compositions include a blend of light ash and dense ash in a ratio of from about 1:2 to about 1:15, more preferably from about 1:2.5 to about 1:12, still more preferably from about 1:3 to about 1:10, even more preferably, from about 1:3.5 to about 1:9, yet more preferably from about 1:4 to about 1:8, still more preferably from about 1:4.5 to 1:7.5, most preferably from about 1:5 to about 1:7 light ash to dense ash.

In a preferred embodiment, the warewash compositions do not include a hydroxide as an alkalinity source or solidification matrix; in some embodiments, a minor amount of hydroxide can be included as a neutralizing agent.

The carbonate controls the pH of the use solution when water is added to the warewash composition to form a use solution. The pH of the use solution must be maintained in the alkaline range in order to provide sufficient detergency properties. In one embodiment, the pH of the use solution is between about 8 and about 14, more preferably, between about 8.5 and about 13.5, still more preferably between about 9 and about 13, most preferably between about 9.5 and about 12.5.

In an aspect of the disclosure, the alkali metal carbonate functions a hydratable salt to form a solid composition. The hydratable salt can be referred to as substantially anhydrous. By substantially anhydrous, it is meant that the component contains less than about 2% by weight water based upon the weight of the hydratable component. The amount of water can be less than about 1% by weight, and can be less than about 0.5% by weight. As one skilled in the art will ascertain, there is no requirement that the hydratable salt be completely anhydrous. In certain embodiments, there is also water of hydration to hydrate the alkalinity source (i.e. hydratable salt). It should be understood that the reference to water includes both water of hydration and free water. The phrase “water of hydration” refers to water which is somehow attractively bound to a non-water molecule. An exemplary form of attraction includes hydrogen bonding. The water of hydration also functions to increase the viscosity of the mixture during processing and cooling to prevent separation of the components. The amount of water of hydration in the detergent composition will depend on the specific alkali metal carbonate and amount of alkali metal carbonate. In addition to water of hydration, the warewash composition may also have free water which isn't attractively bound to a non-water molecule.

Preferably the alkali metal carbonate is in an amount of from about 20 wt. % to about 80 wt. %, more preferably from about 35 wt. % to about 70 wt. %, most preferably from about 45 wt. % to about 65 wt. %.

### Fatty Alcohol Alkoxylate

The warewash compositions comprise a fatty alcohol alkoxylate. Beneficially we have found that a fatty alcohol alkoxylate, in combination with the other ingredients disclosed and herein, can provide the desired detergent and rising properties. Additionally, it can be formulated in a compound that provides a controlled dissolution rate and which has structural integrity.

Fatty alcohol alkoxylates are alcohols with a fatty chain and alkoxylated groups attached; they are distinct from alkyl alkoxylates, which do not have an alcohol group. Preferably the fatty alcohol alkoxyates comprise one or more of ethylene oxide, propylene oxide, and butylene oxide groups. When referring to the amount of an alkyl oxide group in the fatty alcohol alkoxylate, the degree (molar amount) can be referred to as alkoxylation and the groups can be referred to as ethoxylation, propoxylation, and butoxylation. Preferred fatty alcohol alkoxylates have a fatty carbon chain group of about 5 carbons, about 6 carbons, about 7 carbons, about 8 carbons, about 9 carbons, about 10 carbons, about 11 carbons, about 12 carbons, about 13 carbons, about 14 carbons, or about 15 carbons. In a preferred embodiment the fatty alcohol alkoxylate has a fatty carbon chain of from about 5 carbons to about 15 carbons, more preferably from about 6 carbons to about 14 carbons, still more preferably from about 7 carbons to about 13 carbons, yet more preferably from about 8 carbons to about 12 carbons, most preferably from about 9 carbons to about 11 carbons. Preferred alcohol alkoxylates have between about 10 and about 50 moles of alkyl oxide, more preferably between about 15 and about 45 moles, most preferably between about 20 and about 40 moles. In a preferred embodiment, the fatty alcohol alkoxylate has between about 10 and about 20 moles of ethoxylation, more preferably between about 12 and about 17 moles of ethoxylation, most preferably between about 13 and about 16 moles of ethoxylation. In a preferred embodiment, the fatty alcohol alkoxylate has between about 10 and about 20 moles of propoxylation, more preferably between about 13 and about 19 moles of propoxylation, most preferably between about 14 and about 18 moles of propoxylation. In a most preferred embodiment, the fatty alcohol alkoxylate both EO and PO groups in the molar amounts set forth above.

Preferably the fatty alcohol alkoxylate is in an amount of from about 0.1 wt. % to about 12 wt. %, more preferably from about 1 wt. % to about 11 wt. %, most preferably from about 2 wt. % to about 10 wt. %.

### Water Conditioning Agent

The warewash compositions preferably comprise a water conditioning agent. A variety of water conditioning agents can be utilized. Preferred water conditioning agents comprise a an aminocarboxylic acid or salt thereof, a phosphate, a phosphonate, a polymer, or a mixture thereof.

Preferably the water conditioning agent is in the warewash compositions in an amount of from about 5 wt. % to about 40 wt. %, from about 10 wt. % to about 35 wt. %, from about 15 wt. % to about 30 wt. %. Most preferably, the warewash compositions comprise multiple water conditioning agents of different species or categories.

### Aminocarboxylic Acids

The water conditioning agent can comprise an aminocarboxylic acid or salt thereof. Preferred aminocarboxylic acids include, but are not limited to, N-hydroxyethylaminodiacetic acid, ethylenediaminetetraacetic acid (EDTA), hydroxyethylenediaminetetraacetic acid, diethylenetriaminepentaacetic acid, N-hydroxyethyl-ethylenediaminetriacetic acid (HEDTA), diethylenetriaminepentaacetic acid (DTPA), aspartic acid-N,N-diacetic acid (ASDA), methylglycinediacetic acid (MGDA), glutamic acid-N,N-diacetic acid (GLDA), ethylenediaminesuccinic acid (EDDS), 2-hydroxyethyliminodiacetic acid (HEIDA), iminodisuccinic acid (IDS), 3-hydroxy-2-2′-iminodisuccinic acid (HIDS) and other similar acids or salts thereof having an amino group with a carboxylic acid substituent.

### Phosphates

The water conditioning agent can comprise a phosphate. Preferred phospates are condensed phosphates. Examples of condensed phosphates include, but are not limited to: sodium and potassium orthophosphate, sodium and potassium pyrophosphate, sodium tripolyphosphate, and sodium hexametaphosphate. A condensed phosphate may also assist, to a limited extent, in solidification of the detergent composition by fixing the free water present in the composition as water of hydration. A most preferred phosphate is sodium tripolyphosphate.

### Phosphonates

The water conditioning agent can comprise a phosphonate. Particularly suitable phosphonates are the alkali metal salts, such as sodium or potassium the ammonium salts; or the alkylol amine salts where the alkylol has 2 to 3 carbon atoms, such as mono-, di-, or triethanolamine salts. Preferred phosphonates include the organic phosphonates. Preferred organic phosphonates include phosphono butane tricarboxylic acid (PBTC) available from Bayer Corp. in Pittsburgh Pa. under the tradename of BAYHIBIT™ and hydroxy ethylidene diphosphonic acid (HEDP) such as that sold under the tradename of DEQUEST™ 2010 available from Monsanto Chemical Co.

Examples of preferred phosphonates include, but are not limited to: 2-phosphonobutane-1,2,4-tricarboxylic acid (PBTC), 1-hydroxyethane-1,1-diphosphonic acid, CH₂C(OH)[PO(OH)₂]₂; aminotri(methylenephosphonic acid), N[CH₂PO(OH)₂]₃; aminotri(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid), (HO)₂POCH₂N[CH₂CH₂N[CH₂PO(OH)₂]₂]₂; diethylenetriaminepenta(methylenephosphonate), sodium salt (DTPMP), C₉H₍₂₈₋ₓ₎N₃NaₓO₁₅P₅(x=7); hexamethylenediamine(tetramethylenephosphonate), potassium salt, C₁₀H₍₂₈₋ₓ₎N₂KₓO₁₂P₄(x=6); bis(hexamethylene)triamine(pentamethylenephosphonic acid), (HO₂)POCH₂N[(CH₂)₂N[CH₂PO(OH)₂]₂]₂; and phosphorus acid, H₃PO₃. A preferred phosphonate combination is ATMP and HEDP. A neutralized or alkali phosphonate, or a combination of the phosphonate with an alkali source prior to being added into the mixture such that there is little or no heat or gas generated by a neutralization reaction when the phosphonate is added is preferred.

### Polymer

A warewash composition can include a polymer or a polymer system comprised of at least one polycarboxylic acid polymer, copolymer, and/or terpolymer. Particularly suitable polycarboxylic acid polymers, include, but are not limited to, polymaleic acid homopolymers, polyacrylic acid copolymers, and maleic anhydride/olefin copolymers.

Polymaleic acid (C₄H₂O₃)x or hydrolyzed polymaleic anhydride or cis-2-butenedioic acid homopolymer, has the structural formula:

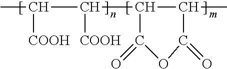

where n and m are any integer. Examples of polymaleic acid homopolymers, copolymers, and/or terpolymers (and salts thereof) which may be used are particularly preferred are those with a molecular weight of about 0 and about 5000, more preferably between about 200 and about 2000 (can you confirm these MWs). Commercially available polymaleic acid homopolymers include the Belclene 200 series of maleic acid homopolymers from BWA™ Water Additives, 979 Lakeside Parkway, Suite 925 Tucker, GA 30084, USA and Aquatreat AR-801 available from AkzoNobel. The polymaleic acid homopolymers, copolymers, and/or terpolymers may be present in a warewash composition from about 0.01 wt. % to about 30 wt. %.

A warewash composition can include polyacrylic acid polymers, copolymers, and/or terpolymers. Poly acrylic acids have the following structural formula:

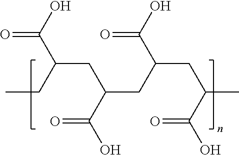

where n is any integer. Examples of suitable polyacrylic acid polymers, copolymers, and/or terpolymers, include but are not limited to, the polymers, copolymers, and/or terpolymers of polyacrylic acids, (C₃H₄O₂)ₙ or 2-Propenoic acid, acrylic acid, polyacrylic acid, propenoic acid.

In a preferred embodiment of a warewash composition comprising a polymer, particularly suitable acrylic acid polymers, copolymers, and/or terpolymers have a molecular weight between about 100 and about 10,000, in a preferred embodiment between about 500 and about 7000, in an even more preferred embodiment between about 1000 and about 5000, and in a most preferred embodiment between about 1500 and about 3500. Examples of polyacrylic acid polymers, copolymers, and/or terpolymers (or salts thereof) which may be used include, but are not limited to, Acusol 448 and Acusol 425 from The Dow Chemical Company, Wilmington Delaware, USA. In particular embodiments it may be desirable to have acrylic acid polymers (and salts thereof) with molecular weights greater than about 10,000. Examples, include but are not limited to, Acusol 929 (10,000 MW) and Acumer 1510 (60,000 MW) both also available from Dow Chemical, AQUATREAT AR-6 (100,000 MW) from AkzoNobel Strawinskylaan 2555 1077 ZZ Amsterdam Postbus 75730 1070 AS Amsterdam. The polyacrylic acid polymer, copolymer, and/or terpolymer may be present in the compositions from about may be present in a warewash composition from about 0.01 wt. % to about 30 wt. %.

Maleic anhydride/olefin copolymers are copolymers of polymaleic anhydrides and olefins. Maleic anhydride (C₂H₂(CO)₂O has the following structure:

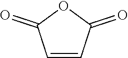

A part of the maleic anhydride can be replaced by maleimide, N-alkyl(C₁₋₄) maleimides, N-phenyl-maleimide, fumaric acid, itaconic acid, citraconic acid, aconitic acid, crotonic acid, cinnamic 10 acid, alkyl (C₁₋₁₈) esters of the foregoing acids, cycloalkyl(C₃₋₈) esters of the foregoing acids, sulfated castor oil, or the like.

At least 95 wt % of the maleic anhydride polymers, copolymers, or terpolymers have a number average molecular weight of in the range between about 700 and about 20,000, preferably between about 1000 and about 100,000.

A variety of linear and branched chain alpha-olefins can be used for the purposes of this disclosure. Particularly useful alpha-olefins are dienes containing 4 to 18 carbon atoms, such as butadiene, chloroprene, isoprene, and 2-methyl-1,5-hexadiene; 1-alkenes containing 4 to 8 carbon atoms, preferably C₄₋₁₀, such as isobutylene, 1-butene, 1-hexene, 1-octene, and the like.

In a preferred embodiment, particularly suitable maleic anhydride/olefin copolymers have a molecular weight between about 1000 and about 50,000, in a preferred embodiment between about 5000 and about 20,000, and in a most preferred embodiment between about 7500 and about 12,500. Examples of maleic anhydride/olefin copolymers which may be used include, but are not limited to, Acusol 460N from The Dow Chemical Company, Wilmington Delaware, USA.

### Optional Additional Ingredients

Various additional optional ingredients can be used in combination with the alkali metal carbonate, fatty alcohol alkoxylate, and water conditioning agent. The is a list of preferred additional optional ingredients can be influenced by the water conditions, anticipated soils, nature of the warewash environment (machine, undercounter, stand alone, commercial, consumer, etc.).

### Acid Source

In some embodiments a warewash composition can include an acid source. Suitable acid sources, can include, organic and/or inorganic acids. Examples of suitable organic acids include carboxylic acids such as but not limited to hydroxyacetic (glycolic) acid, citric acid, formic acid, acetic acid, propionic acid, butyric acid, valeric acid, caproic acid, trichloroacetic acid, urea hydrochloride, and benzoic acid, among others. Organic dicarboxylic acids such as oxalic acid, malonic acid, gluconic acid, itaconic acid, succinic acid, glutaric acid, maleic acid, fumaric acid, adipic acid, and terephthalic acid among others are also useful in accordance with this disclosure. Any combination of these organic acids may also be used intermixed or with other organic acids which allow adequate formation of the warewash compositions.

Inorganic acids that can be included in some embodiments include sulfuric acid, sulfamic acid, methylsulfamic acid, hydrochloric acid, hydrobromic acid, and nitric acid among others. These acids may also be used in combination with other inorganic acids or with those organic acids mentioned above. In a preferred embodiment, the acid is an inorganic acid.

The acid source can be included as a pH modifier or neutralizer in a basic composition to achieve a desired pH.

### Activators

In some embodiments, a warewash composition can have improved the antimicrobial activity or bleaching activity by the addition of a material which, when the composition is placed in use, reacts with the active oxygen to form an activated component. For example, in some embodiments, a peracid or a peracid salt is formed. For example, in some embodiments, tetraacetylethylene diamine can be included within the composition to react with the active oxygen and form a peracid or a peracid salt that acts as an antimicrobial agent. Other examples of active oxygen activators include transition metals and their compounds, compounds that contain a carboxylic, nitrile, or ester moiety, or other such compounds known in the art. In an embodiment, the activator includes tetraacetylethylene diamine; transition metal; compound that includes carboxylic, nitrile, amine, or ester moiety; or mixtures thereof.

In some embodiments, an activator component can include in the range of up to about 25 wt. % of the composition, in some embodiments, in the range of about 0.01 to about 20 wt. %, or in some embodiments, in the range of about 0.05 to 10 wt. % of the warewash composition. In some embodiments, an activator for an active oxygen compound combines with the active oxygen to form an antimicrobial agent.

The activator can be coupled to a warewash composition by any of a variety of methods for coupling one solid cleaning composition to another. For example, the activator can be in the form of a solid that is bound, affixed, glued or otherwise adhered to the solid cleaning composition. Alternatively, the solid activator can be formed around and encasing the solid cleaning composition. By way of further example, the solid activator can be coupled to a warewash composition by the container or package for the composition, such as by a plastic or shrink wrap or film.

### Anti-Etch Agents

The warewash compositions can optionally include an anti-etch agent capable of preventing etching in glass. Examples of suitable anti-etch agents include adding metal ions to the composition such as zinc, zinc chloride, zinc gluconate, aluminum, and beryllium. The corrosion inhibitor can refer to the combination of a source of aluminum ion and a source of zinc ion. The source of aluminum ion and the source of zinc ion provide aluminum ion and zinc ion, respectively, when the solid detergent composition is provided in the form of a use solution. The amount of the corrosion inhibitor is calculated based upon the combined amount of the source of aluminum ion and the source of zinc ion. Anything that provides an aluminum ion in a use solution can be referred to as a source of aluminum ion, and anything that provides a zinc ion when provided in a use solution can be referred to as a source of zinc ion. It is not necessary for the source of aluminum ion and/or the source of zinc ion to react to form the aluminum ion and/or the zinc ion. Aluminum ions can be considered a source of aluminum ion, and zinc ions can be considered a source of zinc ion. The source of aluminum ion and the source of zinc ion can be provided as organic salts, inorganic salts, and mixtures thereof. Exemplary sources of aluminum ion include, but are not limited to: aluminum salts such as sodium aluminate, aluminum bromide, aluminum chlorate, aluminum chloride, aluminum iodide, aluminum nitrate, aluminum sulfate, aluminum acetate, aluminum formate, aluminum tartrate, aluminum lactate, aluminum oleate, aluminum bromate, aluminum borate, aluminum potassium sulfate, aluminum zinc sulfate, and aluminum phosphate. Exemplary sources of zinc ion include, but are not limited to: zinc salts such as zinc chloride, zinc sulfate, zinc nitrate, zinc iodide, zinc thiocyanate, zinc fluorosilicate, zinc dichromate, zinc chlorate, sodium zincate, zinc gluconate, zinc acetate, zinc benzoate, zinc citrate, zinc lactate, zinc formate, zinc bromate, zinc bromide, zinc fluoride, zinc fluorosilicate, and zinc salicylate.

If included, the warewash composition preferably includes from about 0.001 wt-% to about 10 wt-%, more preferably from about 0.01 wt-% to about 7 wt-%, and most preferably from about 0.01 wt-% to about 1 wt-% of an anti-etch agent.

### Anticorrosion Agents

The warewash compositions can optionally include an anticorrosion agent. Anticorrosion agents provide compositions that generate surfaces that are shinier and less prone to biofilm buildup than surfaces that are not treated with compositions having anticorrosion agents.

Preferred anticorrosion agents which can be used according to the invention include phosphonates, phosphonic acids, triazoles, organic amines, sorbitan esters, carboxylic acid derivatives, sarcosinates, phosphate esters, zinc, nitrates, chromium, molybdate containing components, and borate containing components. Exemplary phosphates or phosphonic acids are available under the name Dequest (i.e., Dequest 2000, Dequest 2006, Dequest 2010, Dequest 2016, Dequest 2054, Dequest 2060, and Dequest 2066) from Solutia, Inc. of St. Louis, Mo. Exemplary triazoles are available under the name Cobratec (i.e., Cobratec 100, Cobratec TT-50-S, and Cobratec 99) from PMC Specialties Group, Inc. of Cincinnati, Ohio.

Exemplary organic amines include aliphatic amines, aromatic amines, monoamines, diamines, triamines, polyamines, and their salts. Exemplary amines are available under the names Amp (i.e. Amp-95) from Angus Chemical Company of Buffalo Grove, Ill.; WGS (i.e., WGS-50) from Jacam Chemicals, LLC of Sterling, Kans.; Duomeen (i.e., Duomeen O and Duomeen C) from Akzo Nobel Chemicals, Inc. of Chicago, Ill.; DeThox amine (C Series and T Series) from DeForest Enterprises, Inc. of Boca Raton, Fla.; Deriphat series from Henkel Corp. of Ambler, Pa.; and Maxhib (AC Series) from Chemax, Inc. of Greenville, S.C. Exemplary sorbitan esters are available under the name Calgene (LA-series) from Calgene Chemical Inc. of Skokie, Ill. Exemplary carboxylic acid derivatives are available under the name Recor (i.e., Recor 12) from Ciba-Geigy Corp. of Tarrytown, N.Y. Exemplary sarcosinates are available under the names Hamposyl from Hampshire Chemical Corp. of Lexington, Mass.; and Sarkosyl from Ciba-Geigy Corp. of Tarrytown, N.Y.

If the warewash composition optionally includes an anticorrosion agent, it is preferably included in an amount of between about 0.01 wt. % and about 7.5 wt. %, between about 0.01 wt. % and about 5 wt. % and between about 0.01 wt. % and about 3 wt. %.

### Additional Alkalinity Source

The warewash compositions can optionally include an additional alkalinity source. Additional alkalinity sources can be added to increase the pH so as to achieve a very basic pH or they can be included as a neutralizer. The amount can be influenced by the desired effect (e.g., increasing pH or neutralizing another ingredient).

Examples of suitable additional alkalinity sources include, but are not limited to alkali metal hydroxides, metal silicates, metal borates, organic alkalinity sources, and mixtures thereof. Preferred alkali metal hydroxides, include, but are not limited to sodium hydroxide, potassium hydroxide, and mixtures thereof. Preferred metal silicates include, but are not limited to, sodium silicate, potassium silicate and metasilicate. Preferred metal borates include, but are not limited to, sodium borate, potassium borate, and mixtures thereof.

Organic alkalinity sources are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like. In general, alkalinity sources are commonly available in either aqueous or powdered form.

### Anti-Redeposition Agents

The warewash compositions can optionally include an anti-redeposition agent capable of facilitating sustained suspension of soils in a cleaning or rinse solution and preventing removed soils from being redeposited onto the substrate being cleaned and/or rinsed. Some examples of suitable anti-redeposition agents can include fatty acid amides, fluorocarbon surfactants, complex phosphate esters, styrene maleic anhydride copolymers, and cellulosic derivatives such as hydroxyethyl cellulose, hydroxypropyl cellulose, and the like. A warewash composition can include up to about 10 wt. %, and in some embodiments, in the range of about 1 to about 5 wt. %, of an anti-redeposition agent.

### Dyes/Odorants

Various dyes, odorants including fragrances, perfumes, and other aesthetic enhancing agents may also be included in a warewash composition. Dyes may be included to alter the appearance of the composition, as for example, FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

Fragrances or perfumes that may be included in a warewash composition include, for example, terpenoids such as citronellol, aldehydes such as amyl cinnamaldehyde, a jasmine such as C1S-jasmine or jasmal, vanillin, and the like.

### Enzymes

The warewash compositions can optionally include one or more enzymes, which can provide desirable activity for removal of protein-based, carbohydrate-based, or triglyceride-based soils from substrates such as flatware, cups and bowls, and pots and pans. Enzymes suitable for the inventive composition can act by degrading or altering one or more types of soil residues encountered on a surface thus removing the soil or making the soil more removable by a surfactant or other component of the cleaning composition. Both degradation and alteration of soil residues can improve detergency by reducing the physicochemical forces which bind the soil to the surface or textile being cleaned, i.e., the soil becomes more water soluble. For example, one or more proteases can cleave complex, macromolecular protein structures present in soil residues into simpler short chain molecules which are, of themselves, more readily desorbed from surfaces, solubilized, or otherwise more easily removed by detersive solutions containing said proteases.

Suitable enzymes include a protease, an amylase, a lipase, a gluconase, a cellulase, a peroxidase, or a mixture thereof of any suitable origin, such as vegetable, animal, bacterial, fungal or yeast origin. Preferred selections are influenced by factors such as pH-activity and/or stability optima, thermostability, and stability to active detergents, builders and the like. In this respect bacterial or fungal enzymes are preferred, such as bacterial amylases and proteases, and fungal cellulases. In some embodiments preferably the enzyme is a protease, a lipase, an amylase, or a combination thereof.

If an enzyme is optionally included in the composition, it is preferably in an amount of from about 0.001 wt. % to about 10 wt. %, from about 0.01 wt. % to about 10 wt. %, from about 0.05 wt. % to about 5 wt. %, and more preferably from about 0.1 wt. % to about 1 wt. % of enzyme.

### Fillers

The warewash compositions can optionally include a minor but effective amount of one or more of a filler. Some examples of suitable fillers may include sodium chloride, starch, sugars, C₁-C₁₀ alkylene glycols such as propylene glycol, sulfates, PEG, urea, sodium acetate, magnesium sulfate, sodium acetate, magnesium sulfate, sodium carbonate and the like. In some embodiments, a filler can be included in an amount in the range of up to about 30 wt. %, and in some embodiments, in the range of about 1-15 wt. %.

### Hardening and Solidification Agents

In some embodiments, a hardening/solidification agent can be added to the warewash compositions. Examples of hardening agents include urea, an amide such stearic monoethanolamide or lauric diethanolamide or an alkylamide, and the like; sulfate salts or sulfated surfactants, and aromatic sulfonates, and the like; a solid polyethylene glycol, or a solid EO/PO block copolymer; starches that have been made water-soluble through an acid or alkaline treatment process; various inorganics that impart solidifying properties to a heated composition upon cooling, and the like. Such compounds may also vary the solubility of the composition in an aqueous medium during use such that the active ingredients may be dispensed from the solid composition over an extended period of time.

Suitable aromatic sulfonates include, but are not limited to, sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and/or sodium butyl naphthalene. Preferred aromatic sulfonates include sodium xylene sulfonate and sodium cumene sulfonate.

The amount of solidification agent included in a warewash composition can be dictated by the desired effect. In general, an effective amount of solidification agent is considered an amount that acts with or without other materials to solidify the warewash composition. In certain embodiments it can be desirable to have a secondary solidification agent. In compositions containing secondary solidification the composition may include a secondary solidification agent in an amount in the range of up to about 35 wt. %. In some embodiments, secondary hardening agents is present in an amount of from about 5 to about 30 wt. %, more preferably from about 10 to about 25 wt. %.

### Humectant

The warewash compositions can also optionally include one or more humectants. A humectant is a substance having an affinity for water. The humectant can be provided in an amount sufficient to aid in reducing the visibility of a film on the substrate surface. The visibility of a film on substrate surface is a particular concern when the rinse water contains in excess of 200 ppm total dissolved solids. Accordingly, in some embodiments, the humectant is provided in an amount sufficient to reduce the visibility of a film on a substrate surface when the rinse water contains in excess of 200 ppm total dissolved solids compared to a rinse agent composition not containing the humectant. The terms “water solids filming” or “filming” refer to the presence of a visible, continuous layer of matter on a substrate surface that gives the appearance that the substrate surface is not clean. Some example humectants that can be used include those materials that contain greater than 5 wt. % water (based on dry humectant) equilibrated at 50% relative humidity and room temperature. Exemplary humectants that can be used include glycerin, propylene glycol, sorbitol, alkyl polyglycosides, polybetaine polysiloxanes, and mixtures thereof.

If the warewash composition comprises a humectant, it is preferably in an amount of up to about 30 wt. % based on the total composition, more preferably between about 0.01 wt. % and about 25 wt. %.

### Sanitizers/Anti-Microbial Agents

Some warewash compositions can optionally include a sanitizing agent. Sanitizing agents also known as antimicrobial agents are chemical compositions that can be used in a solid functional material to prevent microbial contamination and deterioration of material systems, surfaces, etc. Generally, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds.

It should also be understood that active oxygen compounds, such as those discussed above in the bleaching agents section, may also act as antimicrobial agents, and can even provide sanitizing activity. In fact, in some embodiments, the ability of the active oxygen compound to act as an antimicrobial agent reduces the need for additional antimicrobial agents within the composition. For example, percarbonate compositions have been demonstrated to provide excellent antimicrobial action. Nonetheless, some embodiments incorporate additional antimicrobial agents.

The given antimicrobial agent, depending on chemical composition and concentration, may simply limit further proliferation of numbers of the microbe or may destroy all or a portion of the microbial population. The terms “microbes” and “microorganisms” typically refer primarily to bacteria, virus, yeast, spores, and fungus microorganisms. In use, the antimicrobial agents are typically formed into a solid functional material that when diluted and dispensed, optionally, for example, using an aqueous stream forms an aqueous disinfectant or sanitizer composition that can be contacted with a variety of surfaces resulting in prevention of growth or the killing of a portion of the microbial population. A three log reduction of the microbial population results in a sanitizer composition. The antimicrobial agent can be encapsulated, for example, to improve its stability.

Some examples of common antimicrobial agents include phenolic antimicrobials such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary antimicrobial agents such as benzalkonium chloride, didecyldimethyl ammonium chloride, choline diiodochloride, tetramethyl phosphonium tribromide. Other antimicrobial compositions such as hexahydro-1,3,5-tris(2-hydroxyethyl)-s- -triazine, dithiocarbamates such as sodium dimethyldithiocarbamate, and a variety of other materials are known in the art for their antimicrobial properties.

In embodiments of warewash compositions which are phosphate-free, and/or sulfate-free, and also include an anti-microbial agent, the anti-microbial is selected to meet those requirements. Embodiments of warewash compositions which include only GRAS ingredients, may exclude or omit anti-microbial agents described in this section.

In some embodiments, a warewash composition comprises, an antimicrobial component in the range of up to about 10% by wt. of the composition, in some embodiments in the range of up to about 5 wt. %, or in some embodiments, in the range of about 0.01 to about 3 wt. %, or in the range of 0.05 to 1% by wt. of the composition.

### Additional Surfactants

In a preferred embodiment, the warewash compositions only include the fatty alcohol alkoxylate and no other surfactants. In an alternative embodiment, the warewash compositions can include one or more surfactants in addition to the fatty alcohol alkoxylate. These can be referred to as a secondary surfactant, additional surfactant and/or co-surfactant. Preferably, a co-surfactant is in solid form. The warewash compositions can include, but are not limited to, detergent compositions, warewash compositions, laundry compositions, rinse aids, hard surface cleaning compositions, and paper/pulp processing compositions. Surfactants that can be included as a co-surfactant in the solidified surfactant compositions and/or as a surfactant in a warewash composition, include, nonionic surfactants, semi polar nonionic surfactants, anionic surfactants, cationic surfactants, amphoteric surfactants, zwitterionic surfactants, and mixtures or combinations of the same.

### Nonionic Surfactants

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful nonionic surfactants include:

Block polyoxypropylene-polyoxyethylene polymeric compounds based upon propylene glycol, ethylene glycol, glycerol, trimethylolpropane, and ethylenediamine as the initiator reactive hydrogen compound. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-flinctional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Neodol™ manufactured by Shell Chemical Co. and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade name Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application for specialized embodiments, particularly indirect food additive applications. All of these ester moieties have one or more reactive hydrogen sites on their molecule which can undergo further acylation or ethylene oxide (alkoxide) addition to control the hydrophilicity of these substances.

Examples of nonionic low foaming surfactants include:

Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. The hydrophobic portion of the molecule weighs from about 2,100 to about 6,700 with the central hydrophile including 10% by weight to 80% by weight of the final molecule.

Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959 to Brown et al. and represented by the formula

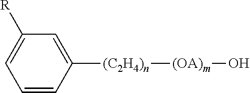

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ(C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the some warewash compositions correspond to the formula: P[(C₃H₆O)ₙ (C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)_{X}H, where x is in the range of from 1 to 3.

A useful class of non-ionic surfactants include the class defined as alkoxylated amines or, most particularly, alcohol alkoxylated/aminated/alkoxylated surfactants. These non-ionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²¹ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H] [(EO)_{z}H] in which R²¹ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Preferred nonionic surfactants for the warewash compositions include alcohol alkoxylates, EO/PO block copolymers, alkylphenol alkoxylates, and the like.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

### Semi-Polar Nonionic Surfactants

The semi-polar type of nonionic surface active agents are another class of nonionic surfactant useful in some warewash compositions. Generally, semi-polar nonionics are high foamers and foam stabilizers, which can limit their application in CIP systems. The semi-polar nonionic surfactants include the amine oxides, phosphine oxides, sulfoxides and their alkoxylated derivatives.

Amine oxides are tertiary amine oxides corresponding to the general formula:

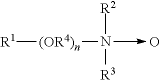

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Useful semi-polar nonionic surfactants also include the water soluble phosphine oxides having the following structure:

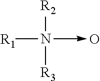

wherein the arrow is a conventional representation of a semi-polar bond; and, R¹ is an alkyl, alkenyl or hydroxyalkyl moiety ranging from 10 to about 24 carbon atoms in chain length; and, R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.

Semi-polar nonionic surfactants useful herein also include the water soluble sulfoxide compounds which have the structure:

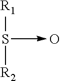

wherein the arrow is a conventional representation of a semi-polar bond; and, R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Suitable nonionic surfactants suitable for use with the compositions include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

### Anionic Surfactants

The warewash compositions can also comprise one or more anionic surfactants. Anionic surfactants are surface active substances which are categorized as anionics because the charge on the hydrophobe is negative; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility. As those skilled in the art understand, anionics are excellent detersive surfactants and are therefore favored additions to heavy duty detergent compositions.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and the aromatic sulfonates with or without substituents.

Anionic carboxylate surfactants suitable for use in the present compositions include carboxylic acids (and salts), such as alkanoic acids (and alkanoates), ester carboxylic acids (e.g. alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g. alkyl carboxyls).

Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

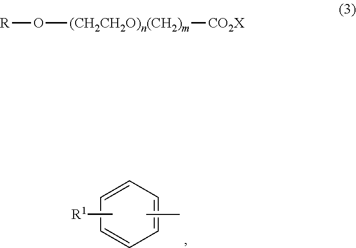

in which R is a C₈ to C₂₂ alkyl group or, in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

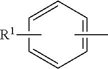

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g. the product Sandopan® DTC, a C₁₃ alkyl polyethoxy (7) carboxylic acid.

### Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y- and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

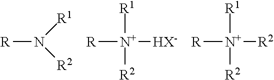

in which, R represents an alkyl chain, R′, R″, and R′″ may be either alkyl chains or aryl groups or hydrogen and X represents an anion. The amine salts and quaternary ammonium compounds are preferred for practical use due to their high degree of water solubility.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

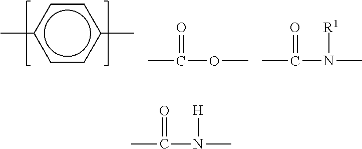

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens.

Y is can be a group including, but not limited to:

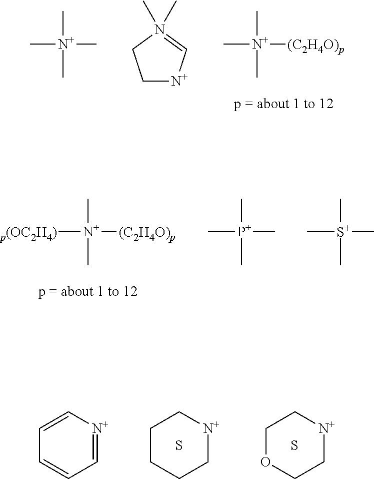

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

### Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having potential application generally have the general formula:

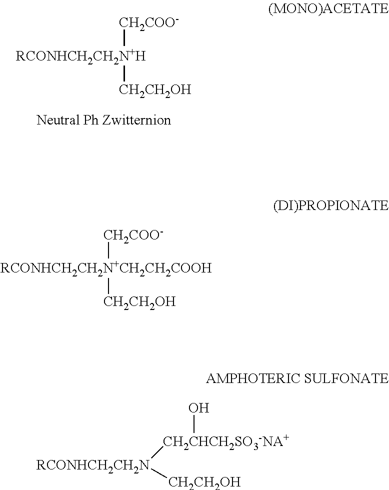

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having potential application include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N+(CH₂—CH₂—CO₂Na)₂—CH₂—CH₂—OH or C₁₂-alkyl-C(O)—N(H)—CH₂—CH₂—N+(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated by reference in their entirety.

### Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

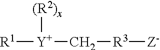

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

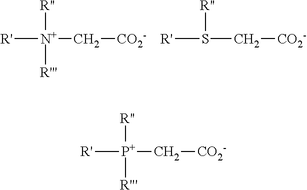

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines potentially useful include those compounds having the formula (R(R¹)₂N+R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated in their entirety.

### Whitening Agents

The warewash compositions can optionally include a whitening agent. Whitening agents can be used for lightening a substrate, and can include bleaching compounds capable of liberating an active halogen species, such as Cl₂, Br₂, —OCl⁻ and/or —OBr⁻, or the like, under conditions typically encountered during the cleansing process. Suitable bleaching agents for use can include, for example, chlorine-containing compounds such as a chlorine, a hypochlorite, chloramines, of the like. Some examples of halogen-releasing compounds include the alkali metal dichloroisocyanurates, chlorinated trisodium phosphate, the alkali metal hypochlorites, monochloramine and dichloroamine, and the like. Encapsulated chlorine sources may also be used to enhance the stability of the chlorine source in the composition.

A whitening agent may also include an agent containing or acting as a source of active oxygen. The active oxygen compound acts to provide a source of active oxygen, for example, may release active oxygen in aqueous solutions. An active oxygen compound can be inorganic or organic, or can be a mixture thereof. Some examples of active oxygen compound include peroxygen compounds, or peroxygen compound adducts. Some examples of active oxygen compounds or sources include hydrogen peroxide, perborates, sodium carbonate peroxyhydrate, phosphate peroxyhydrates, potassium permonosulfate, and sodium perborate mono and tetrahydrate, with and without activators such as tetraacetylethylene diamine, and the like.

The warewash compositions can include a whitening agent in the range of up to about 15 wt. %, more preferably from about 0.01 wt. % to about 12 wt. %, most preferably from about 1 wt. % to about 10 wt. %.

### Methods of Manufacture

The warewash compositions are prepared as solid compositions, the solid compositions can include, but are not limited to granular and pelletized solid compositions, powders, solid block compositions, cast solid block compositions, extruded solid block composition, pressed solid compositions, and others.

In a preferred embodiment, a solid premix is obtained, a liquid premix is obtained, and the surfactant is obtained. These are then combined according to the methods disclosed below. In an embodiment, the surfactant can be in the solid premix (if a solid surfactant) or in the liquid premix (if a liquid surfactant).

Solid particulate warewash compositions can be made by merely blending the dry solid ingredients in appropriate ratios or agglomerating the materials in appropriate agglomeration systems. Pelletized materials can be manufactured by compressing the solid granular or agglomerated materials in appropriate pelletizing equipment to result in appropriately sized pelletized materials. Solid block and cast solid block materials can be made by introducing into a container either a prehardened block of material or a castable liquid that hardens into a solid block within a container. Preferred containers include disposable plastic containers or water-soluble film containers. Other suitable packaging for the composition includes flexible bags, packets, shrink wrap, and water-soluble film such as polyvinyl alcohol.

The solid warewash compositions may be formed using a batch or continuous mixing system. In an exemplary embodiment, a single- or twin-screw extruder is used to combine and mix one or more components at high shear to form a homogeneous mixture. In some embodiments, the processing temperature is at or below the melting temperature of the components. The processed mixture may be dispensed from the mixer by forming, casting or other suitable means, whereupon the warewash composition hardens to a solid form. The structure of the matrix may be characterized according to its hardness, melting point, material distribution, crystal structure, and other like properties according to known methods in the art. Generally, a solid warewash composition is substantially homogeneous with regard to the distribution of ingredients throughout its mass and is dimensionally stable.

In an extrusion process, the liquid and solid components are introduced into final mixing system and are continuously mixed until the components form a substantially homogeneous semi-solid mixture in which the components are distributed throughout its mass. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

In a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

In a pressed solid process, a flowable solid, such as granular solids or other particle solids are combined under pressure. In a pressed solid process, flowable solids of the compositions are placed into a form (e.g., a mold or container). The method can include gently pressing the flowable solid in the form to produce the solid warewash composition. Pressure may be applied by a block machine or a turntable press, or the like. Pressure may be applied at about 1 to about 3000 psi, about 5 to about 2500 psi, or about 10 psi to about 2000 psi. As used herein, the term “psi” or “pounds per square inch” refers to the actual pressure applied to the flowable solid being pressed and does not refer to the gauge or hydraulic pressure measured at a point in the apparatus doing the pressing. The method can include a curing step to produce the solid composition. As referred to herein, an uncured composition including the flowable solid is compressed to provide sufficient surface contact between particles making up the flowable solid that the uncured composition will solidify into a stable solid composition. A sufficient quantity of particles (e.g., granules) in contact with one another provides binding of particles to one another effective for making a stable solid composition. Inclusion of an optional curing step may include allowing the pressed solid to solidify for a period of time, such as a few hours, or about 1 day (or longer). In additional aspects, the methods could include vibrating the flowable solid in the form or mold, such as the methods disclosed in U.S. Pat. No. 8,889,048, which is herein incorporated by reference in its entirety.

The use of pressed solids provide numerous benefits over conventional solid block or tablet compositions requiring high pressure in a tablet press, or casting requiring the melting of a composition consuming significant amounts of energy, and/or by extrusion requiring expensive equipment and advanced technical know-how. Pressed solids overcome such various limitations of other solid formulations for which there is a need for making solid compositions. Moreover, pressed solid compositions retain its shape under conditions in which the composition may be stored or handled.

By the term “solid”, it is meant that the hardened composition will not flow and will substantially retain its shape under moderate stress or pressure or mere gravity. A solid may be in various forms such as a powder, a flake, a granule, a pellet, a tablet, a lozenge, a puck, a briquette, a brick, a solid block, a unit dose, or another solid form known to those of skill in the art. The degree of hardness of the solid cast composition and/or a pressed solid composition may range from that of a fused solid product which is relatively dense and hard, for example, like concrete, to a consistency characterized as being a hardened paste. In addition, the term “solid” refers to the state of the warewash composition under the expected conditions of storage and use of the solid composition. In general, it is expected that the warewash composition will remain in solid form when exposed to temperatures of up to approximately 37.8° C. and particularly up to approximately 48.9° C.

The resulting solid composition may take forms including, but not limited to: a cast solid product; an extruded, molded or formed solid pellet, block, tablet, powder, granule, flake; pressed solid; or the formed solid can thereafter be ground or formed into a powder, granule, or flake. In an exemplary embodiment, extruded pellet materials formed by the solidification matrix have a weight of between approximately 50 grams and approximately 250 grams, extruded solids formed by the composition have a weight of approximately 100 grams or greater, and solid block detergents formed by the composition have a mass of between approximately 1 and approximately 10 kilograms. The solid compositions provide for a stabilized source of functional materials. In some embodiments, the solid composition may be dissolved, for example, in an aqueous or other medium, to create a concentrated and/or use solution. The solution may be directed to a storage reservoir for later use and/or dilution, or may be applied directly to a point of use.

The following patents disclose various combinations of solidification, binding and/or hardening agents that can be utilized in the solid compositions. The detailed descriptions from the following U.S. patents are incorporated herein by reference: U.S. Pat. Nos. 7,153,820; 7,094,746; 7,087,569; 7,037,886; 6,831,054; 6,730,653; 6,660,707; 6,653,266; 6,583,094; 6,410,495; 6,258,765; 6,177,392; 6,156,715; 5,858,299; 5,316,688; 5,234,615; 5,198,198; 5,078,301; 4,595,520; 4,680,134; RE32,763; and RE32818.

### Method of Use—Cleaning an Article in a Dish Machine

Methods of using the solid warewash compositions generally comprise contacting the ware with a warewash composition (in concentrated or diluted form); and rinsing the ware. Any suitable ware can be cleaned. In a preferred embodiment the contacting is performed in a dishmachine, most preferably an undercounter dishmachine. In a preferred embodiment, the warewash composition provides a use solution having a pH of between about 9 and about 14 upon dissolution. As discussed herein, the warewash composition preferably has a controlled dissolution rate and does not fully dissolve during a single wash cycle.

In a preferred method of use the solid warewash composition is inserted into a dispenser in or associated with a dish machine, most preferably an undercounter dishmachine. In a preferred embodiment, the solid warewash composition may be provided as a multiple-use dosage having between about 2 and about 100 doses per solid composition, more preferably 3 to 70, most preferably 4 to 50. In another embodiment, the solid warewash composition can be formulated in a single-use composition, where it is used one time in a wash.

The methods can also include forming a use solution with the solid warewash composition and water, contacting a soil on an article in the dish machine with the wash solution, removing the soil, and rinsing the article with potable water without requiring the use of a separate rinse aid composition. The rinse is with potable water only.

In another embodiment, the methods of the present invention may involve providing the individual components of the solid warewash composition separately and mixing the individual components in situ with water to form a desired wash solution.

When carrying out the methods of the invention, the solid warewash compositions described above are inserted into a dispenser of a dish machine. The dispenser may be selected from a variety of different dispensers depending of the physical form of the composition. For example, a liquid composition may be dispensed using a pump, either peristaltic or bellows for example, syringe/plunger injection, gravity feed, siphon feed, aspirators, unit dose, for example using a water soluble packet such as polyvinyl alcohol, or a foil pouch, evacuation from a pressurized chamber, or diffusion through a membrane or permeable surface. If the composition is a gel or a thick liquid, it may be dispensed using a pump such as a peristaltic or bellows pump, syringe/plunger injection, caulk gun, unit dose, for example using a water soluble packet such as polyvinyl alcohol or a foil pouch, evacuation from a pressurized chamber, or diffusion through a membrane or permeable surface. Preferably, when the composition is a solid or powder, the composition may be dispensed using a spray, flood, auger, shaker, tablet-type dispenser, unit dose using a water soluble packet such as polyvinyl alcohol or foil pouch, or diffusion through a membrane or permeable surface. The dispenser may also be a dual dispenser in which one component, is dispensed on one side and another component is dispensed on another side. These exemplary dispensers may be located in or associated with a variety of dish machines including under the counter dish machines, bar washers, door machines, conveyor machines, or flight machines. The dispenser may be located inside the dish machine, remote, or mounted outside of the dishwasher. A single dispenser may feed one or more dish machines.

Once the solid warewash composition is inserted into the dispenser, the wash cycle of the dish machine is started and a wash solution is formed. The wash solution comprises the solid warewash composition and water from the dish machine. The water may be any type of water including hard water, soft water, clean water, or dirty water. The most preferred wash solution is one that maintains the preferred pH ranges of about 7 to about 11.5, more preferably about 9.5 to about 11.5, as measured by a pH probe based on a solution of the composition in a 16 gallon dish machine. The same probe may be used to measure millivolts if the probe allows for both functions, simply by switching the probe from pH to millivolts. The dispenser or the dish machine may optionally include a pH probe to measure the pH of the wash solution throughout the wash cycle. The actual concentration or water to detergent ratio depends on the particular surfactant used. Exemplary concentration ranges may include up to 3000 ppm, preferably 1 to 3000 ppm, more preferably 100 to 3000 ppm and most preferably 300 to 2000 ppm. Again, the actual concentration used depends on the surfactant chosen.

A use solution can have an elevated temperature (i.e. heated to an elevated temperature when used according to the methods of the invention. In one example, a use solution having a temperature between approximately 45° C. and about 100° C., between about 140° F. and approximately 185° F. is contacted with the substrate to be cleaned. In another example, a use solution having a temperature between approximately 50° C. and approximately 85° C. is contacted with the substrate to be cleaned.

After the wash solution is formed, the wash solution contacts a soil on an article in the dish machine. Examples of soils include soils typically encountered with food such as proteinaceous soils, hydrophobic fatty soils, starchy and sugary soils associated with carbohydrates and simple sugars, soils from milk and dairy products, fruit and vegetable soils, and the like. Soils can also include minerals, from hard water for example, such as potassium, calcium, magnesium, and sodium. Articles that may be contacted include articles made of glass, plastic, aluminum, steel, copper, brass, silver, rubber, wood, ceramic, and the like. Articles include things typically found in a dish machine such as glasses, bowls, plates, cups, pots and pans, bakeware such as cookie sheets, cake pans, muffin pans etc., silverware such as forks, spoons, knives, cooking utensils such as wooden spoons, spatulas, rubber scrapers, utility knives, tongs, grilling utensils, serving utensils, etc. The wash solution may contact the soil in a number of ways including spraying, dipping, sump-pump solution, misting and fogging.

Once the wash solution has contacted the soil, the soil is removed from the article. The removal of the soil from the article is accomplished by the chemical reaction between the wash solution and the soil as well as the mechanical action of the wash solution on the article depending on how the wash solution is contacting the article.

Once the soil is removed, the articles are rinsed as part of the dish machine wash cycle employing potable water without the use of a separate or additional rinse aid composition.

The methods can include more steps or fewer steps than laid out here. For example, the method can include additional steps normally associated with a dish machine wash cycle. For example, the method can also optionally include the use of an acidic detergent. For example, the method can optionally include alternating the acidic detergent with an alkaline detergent as described.

### PREFERRED EMBODIMENTS

The present disclosure is further defined by the following numbered embodiments:
1. A warewash composition comprising: from about 20 wt. % to about 80 wt. % of an alkali metal carbonate; from about 0.1 wt. % to about 12 wt. % of a fatty alcohol alkoxylate, wherein the fatty alcohol alkoxylate has between about 10 and about 20 moles of ethoxylation, between about 10 and about 20 moles of propoxylation, and a carbon chain length of from about 5 to about 15; and a water conditioning agent; wherein the warewash composition is a solid.
2. The warewash composition of embodiment 1, wherein the solid is a pressed solid, cast solid, or extruded solid.
3. The warewash composition of embodiment 2, wherein the solid is a pressed solid.
4. The warewash composition of any one of embodiments 1-3, wherein the water conditioning agent comprises a polycarboxylic acid polymer, a polycarboxylic acid copolymer, a polycarboxylic acid terpolymer, an aminocarboxylic acid or salt thereof, a phosphate, a phosphonate, or a mixture thereof.
5. The warewash composition of embodiment 4, wherein the water conditioning agent is selected from the group consisting of a polycarboxylic acid polymer, sodium triphosphate, a phosphonate, an aminocarboxylic acid or salt thereof, and mixtures thereof.
6. The warewash composition of any one of embodiments 1-5, wherein the fatty alcohol alkoxylate has between about 12 and about 17 moles of ethoxylation, between about 13 and about 19 moles of propoxylation, and a carbon chain length of from about 7 to about 13.
7. The warewash composition of anyone of embodiments 1-6, wherein the fatty alcohol alkoxylate is a C₁₀ fatty alcohol alkoxylate.
8. The warewash composition of any one of embodiments 1-7, wherein the composition further comprises a whitening agent.
9. The warewash composition of embodiment 8, wherein the whitening agent is in an amount of from about 0.01 wt. % to about 12 wt. %.
10. The warewash composition of any one of embodiments 1-9, wherein the composition further comprises an etch protectant.
11. The warewash composition of embodiment 10, wherein the etch protectant comprises sodium aluminate.
12. The warewash composition of any one of embodiments 1-11, wherein the alkali metal carbonate is blend of light ash and dense ash in a ratio of between about 1:2 to about 1:15 light ash to dense ash.
13. The warewash composition of any one of embodiments 1-12, wherein the water conditioning agent is in an amount of from about 10 wt. % to about 35 wt. %.
14. The warewash composition of any one of embodiments 1-13, wherein the fatty alcohol alkoxylate is in a concentration of between about 3 wt. % and about 9 wt. %.
15. The warewash composition of any one of embodiments 1-14, further comprising an anticorrosion agent, an antideposition agent, builder, a dye, an enzyme, a neutralizing agent, an odorant, a sanitizer, or a mixture thereof.
16. The warewash composition of any one of embodiments 1-15, wherein the composition is substantially free of alkyl alkoxylates.
17. The warewash composition of any one of embodiments 1-16, wherein the composition is phosphorus free.
18. The warewash composition of any one of embodiments 1-17, wherein the composition is free of additional surfactants.
19. The warewash composition of any one of embodiments 1-18, wherein the composition does not crack or crumble under ambient conditions.
20. The warewash composition of any one of embodiments 1-19, wherein the composition has a controlled dissolution rate.
21. A method of manufacturing the warewash composition of any one of embodiments 1-20 comprising: obtaining a solid premix, a liquid premix, and the fatty alcohol alkoxylate; wherein the solid mixture comprises the alkali metal carbonate, and the liquid premix comprises the water conditioning agent; combining the solid premix, liquid premix, and the fatty alcohol alkoxylate to form a mixture; solidifying the mixture.
22. The method of embodiment 21, wherein solidifying is pressing, casting or extruding.
23. The method of embodiment 22, wherein the solidifying is pressing.
24. A method of cleaning and rinsing ware comprising: contacting the ware with the warewash composition of any one of embodiments 1-20; and rinsing the ware.
25. The method of embodiment 24, wherein the ware comprises one or more of glass, ceramic, plastic, and metal.
26. The method of any one of embodiments 24-25, wherein the contacting is performed in a dishmachine.
27. The method of embodiment 26, wherein the dishmachine is an undercounter dishmachine.
28. The method of any one of embodiments 24-27, wherein the warewash composition provides a use solution having a pH of between about 9 and about 14 upon dissolution.
29. The method of any one of embodiments 24-28, wherein the warewash composition has a controlled dissolution rate.
30. The method of embodiment 29, wherein the warewash composition does not fully dissolve during a single wash cycle.

### EXAMPLES

Embodiments are further defined in the following non-limiting Examples. It should be understood that these Examples, while indicating certain embodiments, are given by way of illustration only. From the above discussion and these Examples, one skilled in the art can ascertain the essential characteristics of this disclosure, and without departing from the spirit and scope thereof, can make various changes and modifications of the embodiments to adapt it to various usages and conditions. Thus, various modifications of the embodiments, in addition to those shown and described herein, will be apparent to those skilled in the art from the foregoing description. Such modifications are also intended to fall within the scope of the appended claims.

### Example 1

The basic concept of the applicability of the 2-in-1 chemistry approach in a professional dish washing machine has been tested by dosing directly into the wash tank a combination of a new 2:1 detergent and rinse combination, made according to Table 2.

TABLE 2

| Raw Materials | Formula 1 |
|---|---|
| Dense Ash | 46.08% |
| Sodium Triphosphate | 22.50% |
| Light Ash | 7.0% |
| KOH, 50% | 0.95% |
| Sodium Aluminate | 0.21% |
| Dequest (HEDP) | 3.60% |
| Acusol 445 | 2.24% |
| Plurafac SLF 180 | 5.6% |
| Chlorinated Bleach | 8.82% |
| | 100% |

The standard protocol for comparing detergent and rinse formulas/products in professional dish washing machines is as follows: fill the machine with demineralized water; check the amount of water with a water meter; add 1.0 g/L product in the wash tank; put the rack with one tray into the machine and start a 60 second cleaning cycle; after the rinse arms stopped after rinsing, open the machine and carefully take the rack out of the machine; start a 60 second countdown; weigh a piece of paper; after 60 seconds, take the tray carefully out of the rack and, with the tray in a horizontal position, wipe all the water from the front with the wipe; weigh again the piece of paper and note the increase in weight. Repeat these steps and measurements 10 times for each formula/product.

In this set of experiments, a constant detergent concentration of 1.0 g/L was applied directly into the wash tank, while either no rinse aid was applied or a rinse aid concentration of 0.3 g/L was used. The experiments were compared to an experiment in which the same concentration of detergent was used (1.0 g/L), but without the rinse additive which is in the 2:1 formulation. A standard concentration of a liquid ware washing detergent (2.0 g/L) and rinse aid (0.3 g/L) was applied by directly dosing into the rinse water entering the dish washer through the rinse arms, which is the standard protocol in the professional ware wash process, and contrary to the 2-in-1 approach, where the rinse aid is dosed directly into the wash tank in addition to the detergent.

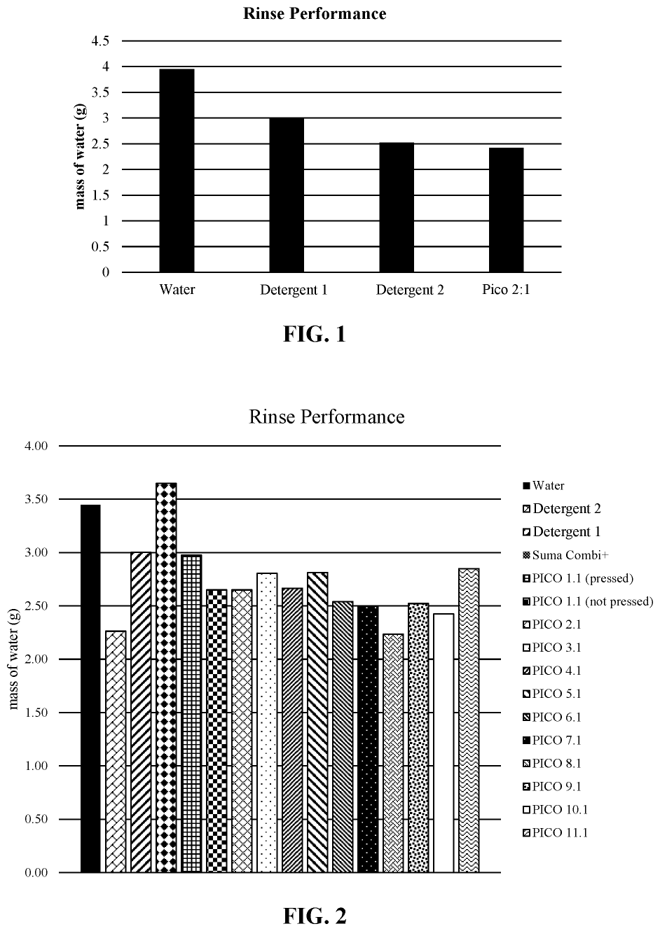

To document the rinsing efficacy of the rinse aid used in the different experiments (2-in-1 with different concentration vs. standard protocol with 0.3 g/L rinse aid), the remaining water left on polypropylene trays after a single cleaning cycle was detected. The tested products were:
a) water (as a baseline/control);
b) a commercially available solid alkaline detergent (Detergent 1) with a constant detergent concentration of 1.0 g/L (to compare the results with a normal alkaline detergent) without additional rinse additives;
c) a commercially available liquid warewash with a commercially available rinse aid with a constant detergent concentration of 2.0 g/L and a rinse aid concentration of 0.3 g/L; and
d) a test composition of the 2:1 solid formulation with a constant detergent concentration of 1.0 g/L added to the wash tank without additional rinse products.
   The respective results can be found in Table 3 and FIG. 1.

TABLE 3

| Tested Product | Run #1 | Run #2 | Run #3 | Run #4 | Run #5 | Run #6 | Run #7 | Run #8 | Run #9 | Run #10 | Average |
|---|---|---|---|---|---|---|---|---|---|---|---|
| Water | 3.17 | 4.45 | 3.38 | 3.55 | 4.05 | 3.14 | 3.40 | 3.18 | 3.16 | 2.98 | 3.45 |
| Detergent 1 | 3.13 | 3.26 | 3.09 | 2.93 | 2.83 | 2.72 | 2.94 | 3.51 | 2.73 | 2.88 | 3.00 |
| Detergent 2 | 2.93 | 2.96 | 2.39 | 2.32 | 2.20 | 2.40 | 2.61 | 2.19 | 2.60 | 2.56 | 2.52 |
| Pico 2:1 (Solid) | 2.72 | 2.21 | 2.45 | 2.49 | 2.40 | 2.32 | 2.47 | 2.24 | 2.67 | 2.27 | 2.42 |

As it is clearly visible from the diagram, by using 1.0 g/L of the 2:1 solid formulation a similar drying result was found as with using 2.0 g/L of the liquid detergent and 0.3 g/L of the rinse aid product, which is separately dosed through the rinse arms. Accordingly, the rinsing effect can be achieved with a 2-in-1 formulation containing the respective rinse surfactant added to a base detergent mixture dosed at the same time in the wash tank.

### Example 2

The 2:1 solid formulation of Table 2 was further evaluated. Table 4 shows the percentage of the base formula (basis), the liquid premix, and the surfactant premix. The basis and liquid premix were prepared according to Tables 5 and 6. Various surfactants and combinations of surfactants, as described in Table 7, were compared against each other for efficacy.

TABLE 4
2:1 Solid Formulation

| Component | % in Formulation [%] | amount [g] |
|---|---|---|
| Basis | 87.4 | 87.4 |
| Liquid premix | 7 | 7 |
| Surfactant premix | 5.6 | 5.6 |

TABLE 5
Basis

| | Formulation .1 | | Formulation .2 | |
|---|---|---|---|---|
| | % in | | % in | |
| | Formulation | % Basis | Formulation | % Basis |
| Component | [%] | [%] | [%] | [%] |
| Dense Ash | 46.08 | 52.72 | 50.14 | 64.83 |
| Sodium | 22.5 | 25.74 | 0 | 0 |
| Triphosphate | | | | |
| MGDA (granular) | 0 | 0 | 12.00 | 15.52 |
| Chlorinated | 8.82 | 10.09 | 0 | 0 |
| Bleach | | | | |
| Crosslinked | 0 | 0 | 0.20 | 0.26 |
| polyacrylate | | | | |
| Light Ash | 10 | 11.44 | 15.00 | 19.39 |

TABLE 6
Liquid Premix

| | Formulation .1 | | Formulation .2 | |
|---|---|---|---|---|
| | % in | % Liquid | % in | % Liquid |
| | Formulation | Premix | Formulation | Premix |
| Component | [%] | [%] | [%] | [%] |
| KOH, 50% | 0.95 | 13.57 | 0 | 0 |
| Sodium | 0.21 | 3 | 0.21 | 1.22 |
| Aluminate | | | | |
| Dequest (HEDP) | 3.6 | 51.43 | 0 | 0 |
| GLDA, 47% | 0 | 0 | 5.00 | 29.05 |
| Acusol 445 | 2.24 | 32 | 12.00 | 69.73 |

TABLE 7

| Surfactant Premix | #1 | #2 | #3 | #4 | #5 | #6 | #7 | #8 | #9 | #10 | #11 |
|---|---|---|---|---|---|---|---|---|---|---|---|
| Component | % in Form | % in Form | % in Form | % in Form | % in Form | % in Form | % in Form | % in Form | % in Form | % in Form | % in Form |
| Pluronic RPE | 3.6 | | 3.6 | 2 | 5.6 | | 2 | | 2 | | |
| 2520 | | | | | | | | | | | |
| Fatty Alcohol | 1 | | | | | | | 5.6 | 3.6 | | |
| (C12-C14) EO | | | | | | | | | | | |
| Iso Tridecyl | 1 | | | | | | | | | | |
| alcohol | | | | | | | | | | | |
| Polyalkylene | | 5.6 | 2 | 3.6 | | | | | | | |
| glycol IBC | | | | | | | | | | | |
| (Tergitol L 64) | | | | | | | | | | | |
| Alcohol | | | | | | 5.6 | 3.6 | | | | |
| Alkoxylate DRM | | | | | | | | | | | |
| (Tergitol L 62E) | | | | | | | | | | | |
| Plurafac SLF 180 | | | | | | | | | | 5.6 | |
| Aduxol HDOC- | | | | | | | | | | | 5.6 |
| 5055-08 | | | | | | | | | | | |

As in Example 1, the rinsing efficacy of the 2:1 formulation with the various surfactant premixes of Table 6, was compared to water, and different commercially available detergents and rinse aid products, including, Detergent 1 (a solid warewash detergent), Detergent 2 (a liquid warewash detergent and a rinse aid), and Suma Combi+ (a commercially available liquid warewash with built-in rinse aid). The formulations were evaluated using the same methods as in Example 1 above. Results of rinsing efficacy of the formulations are shown in FIG. 2 and Table 8 below.

TABLE 8

| Tested Product | Run #1 | Run #2 | Run #3 | Run #4 | Run #5 | Run #6 | Run #7 | Run #8 | Run #9 | Run #10 | Avg. |
|---|---|---|---|---|---|---|---|---|---|---|---|
| Water | 3.17 | 4.45 | 3.38 | 3.55 | 4.05 | 3.14 | 3.40 | 3.18 | 3.16 | 2.98 | 3.45 |
| Detergent 1 | 3.13 | 3.26 | 3.09 | 2.93 | 2.83 | 2.72 | 2.94 | 3.51 | 2.73 | 2.88 | 3.00 |
| PICO 1.1 (pressed) | 2.80 | 3.03 | 2.96 | 2.93 | 2.97 | 3.19 | 2.36 | 3.45 | 3.09 | — | 2.98 |
| PICO 1.1 (not pressed) | 2.58 | 2.15 | 2.89 | 2.33 | 2.71 | 2.59 | 2.47 | 3.05 | 2.51 | 3.22 | 2.65 |
| PICO 2.1 | 2.80 | 2.45 | 2.87 | 2.83 | 2.69 | 2.26 | 2.57 | 2.77 | 2.53 | 2.73 | 2.65 |
| PICO 3.1 | 2.24 | 3.10 | 2.75 | 2.97 | 2.68 | 3.11 | 2.96 | 2.79 | 2.68 | 2.77 | 2.81 |
| PICO 4.1 | 2.30 | 2.82 | 2.42 | 2.73 | 2.76 | 2.55 | 2.70 | 2.74 | 3.03 | 2.60 | 2.67 |
| PICO | 2.74 | 2.51 | 3.18 | 2.93 | — | 2.93 | 3.15 | — | 2.45 | 2.61 | 2.81 |
| PICO 6.1 | 2.32 | 2.21 | 2.28 | 2.84 | 2.26 | 2.68 | 2.68 | 2.56 | 2.71 | 2.86 | 2.54 |
| PICO 7.1 | 2.79 | 2.21 | 2.46 | 2.19 | 2.87 | 2.25 | 2.85 | 2.72 | 2.25 | 2.39 | 2.50 |
| PICO 7.1 (2) | 2.68 | 2.71 | 2.74 | 2.75 | 2.77 | 2.80 | 2.88 | 2.91 | 2.92 | 3.03 | 2.82 |
| PICO 7.1M | 2.16 | 2.12 | 2.57 | 2.35 | 2.63 | 2.58 | 2.37 | 2.64 | 2.13 | 2.59 | 2.41 |
| PICO 7.2 | 2.86 | 3.09 | 2.17 | 2.52 | 2.67 | 2.48 | 3.18 | 2.92 | 2.54 | 2.46 | 2.69 |
| PICO 8.1 | 2.16 | 2.07 | 2.08 | 2.23 | 2.34 | 2.42 | 2.15 | 2.29 | 2.26 | 2.35 | 2.24 |
| PICO 8.1M | 2.28 | 2.27 | 1.83 | 2.45 | 2.30 | 2.23 | 2.51 | 2.33 | 2.31 | 2.41 | 2.29 |
| PICO 9.1 | 2.30 | 2.41 | 2.42 | 2.66 | 2.51 | 2.89 | 2.60 | 2.52 | 2.62 | 2.29 | 2.52 |
| PICO 10.1 | 2.72 | 2.21 | 2.45 | 2.49 | 2.40 | 2.32 | 2.47 | 2.24 | 2.67 | 2.27 | 2.42 |
| PICO 11.1 | 2.95 | 2.26 | 2.65 | 2.75 | 3.10 | 2.81 | 2.98 | 2.88 | 2.98 | 3.13 | 2.85 |
| Detergent 2 (1) | 2.09 | 2.14 | 2.41 | 2.26 | 2.31 | 2.42 | 2.14 | 2.23 | 2.24 | 2.39 | 2.26 |
| Detergent 2 (2) | 2.93 | 2.96 | 2.39 | 2.32 | 2.20 | 2.40 | 2.61 | 2.19 | 2.60 | 2.56 | 2.52 |
| Suma Combi+ | 3.11 | 3.47 | 3.65 | 3.84 | 3.61 | 3.90 | 4.10 | 3.63 | 3.06 | 4.11 | 3.65 |
| Suma Combi+ (2) | 4.17 | 3.63 | 4.29 | 4.45 | 3.00 | 3.46 | 3.80 | 3.41 | 3.66 | 3.95 | 3.78 |

The Formulas referenced in Table 8 correspond to those in Tables 5-7, where Table 7 provides the surfactant and Tables 5 and 6 provide the solid (basis) and liquid premixes used to prepare the tested formulation. Where designated “0.1” the tested formulation phosphorus as shown in Tables 5 and 6 (e.g., inclusion of STPP and HEDP). Where designated “0.2” the formulation is phosphorus-free and does not include a phosphate or phosphonate.

As shown in FIG. 2 and Table 8, the formula 8.1 (with the fatty alcohol C₁₂-C₁₄ EO surfactant) showed the best results, even better than the commercial detergent and rinse aid formulations (Detergent 2). All formulations showed comparable or improved results from the commercial detergent formulation (Detergent 1).

### Example 3

Press experiments were done in order to manufacture a solid prototype of a formula that contains the combination of raw materials in the solid base detergent and the liquid rinse aid as set forth in Tables 4-7. The testing established that the compositions could be successfully pressed.

The disclosures being thus described, it will be obvious that the same may be varied in many ways. Such variations are not to be regarded as a departure from the spirit and scope of the disclosures and all such modifications are intended to be included within the scope of the following claims. The above specification provides a description of the manufacture and use of the disclosed compositions and methods. Since many embodiments can be made without departing from the spirit and scope of the disclosure. From the foregoing, it can be seen that the present disclosure accomplishes at least all of the stated objectives.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A warewash composition comprising:
from about 20 wt. % to about 80 wt. % of an alkali metal carbonate;
from about 0.1 wt. % to about 12 wt. % of a fatty alcohol alkoxylate, wherein the fatty alcohol alkoxylate has between about 10 and about 20 moles of ethoxylation, between about 10 and about 20 moles of propoxylation, and a carbon chain length of from about 5 to about 15; and
a water conditioning agent;
wherein the warewash composition is a solid.

2. The warewash composition of claim 1, wherein the solid is a pressed solid, cast solid, or extruded solid.

3. The warewash composition of claim 1, wherein the water conditioning agent comprises a polycarboxylic acid polymer, a polycarboxylic acid copolymer, a polycarboxylic acid terpolymer, an aminocarboxylic acid or salt thereof, a phosphate, a phosphonate, or a mixture thereof; wherein the water conditioning agent is in an amount of from about 10 wt. % to about 35 wt. %.

4. The warewash composition of claim 1, wherein the fatty alcohol alkoxylate has between about 12 and about 17 moles of ethoxylation, between about 13 and about 19 moles of propoxylation, and a carbon chain length of from about 7 to about 13.

5. The warewash composition of claim 4, wherein the fatty alcohol alkoxylate is a C₁₀ fatty alcohol alkoxylate.

6. The warewash composition of claim 1, wherein the composition further comprises a whitening agent wherein the whitening agent is in an amount of from about 0.01 wt. % to about 12 wt. %.

7. The warewash composition of claim 1, wherein the composition further comprises an etch protectant.

8. The warewash composition of 1, wherein the alkali metal carbonate is blend of light ash and dense ash in a ratio of between about 1:2 to about 1:15 light ash to dense ash.

9. The warewash composition of claim 1, further comprising an anticorrosion agent, an antideposition agent, builder, a dye, an enzyme, a neutralizing agent, an odorant, a sanitizer, or a mixture thereof.

10. The warewash composition of claim 1, wherein the composition is substantially free of alkyl alkoxylates, phosphorus, and/or additional surfactants.

11. The warewash composition of claim 1, wherein the composition does not crack or crumble under ambient conditions.

12. The warewash composition of claim 1, wherein the composition has a controlled dissolution rate.

13. A method of manufacturing a warewash composition comprising:
obtaining a solid premix, a liquid premix, and the fatty alcohol alkoxylate; wherein the solid mixture comprises the alkali metal carbonate, and the liquid premix comprises the water conditioning agent;
combining the solid premix, liquid premix, and the fatty alcohol alkoxylate to form a mixture;
solidifying the mixture.

14. The method of claim 13, wherein solidifying is pressing, casting or extruding.

15. The method of claim 14, wherein the solidifying is pressing.

16. A method of cleaning and rinsing ware comprising:
contacting the ware with the warewash composition of claim 1 in a dishmachine; and
rinsing the ware; wherein the ware comprises one or more of glass, ceramic, plastic, and metal.

17. The method of claim 16, wherein the dishmachine is an undercounter dishmachine.

18. The method of claim 16, wherein the warewash composition provides a use solution having a pH of between about 9 and about 14 upon dissolution.

19. The method of claim 16, wherein the warewash composition has a controlled dissolution rate.

20. The method of claim 19, wherein the warewash composition does not fully dissolve during a single wash cycle.
